(19) United States
(12) Patent Application Publication
(10) Pub. No.: US 2018/0121971 A1
(43) Pub. Date: May 3, 2018

(54) METHOD AND SYSTEM FOR PARKING RATE ESTIMATION BASED ON GEOLOCATION AND PAYMENT HISTORY

(71) Applicant: MasterCard International Incorporated, Purchase, NY (US)

(72) Inventors: Nidhi TANEJA, New Dehli (IN); Adarsh Kumar RECRIWAL, New Dehli (IN); Pulkit GUPTA, Gurgaon (IN)

(73) Assignee: MasterCard International Incorporated, Purchase, NY (US)

(21) Appl. No.: 15/335,879

(22) Filed: Oct. 27, 2016

(51) Int. Cl. G06Q 30/02; G06F 17/30

(52) U.S. Cl. CPC G06Q 30/0284; G06Q 2240/00; G06F 17/30241; G06F 17/30477

(57) ABSTRACT

A method for estimation of parking rates based on location and transaction data includes: storing transaction data entries, each including a geographic location or merchant identifier and transaction amount; storing location data entries, each including a geographic location and a length of time; identifying a subset of transaction data entries where the included geographic location or merchant identifier are associated with a parking area; identifying a subset of location data entries where the included geographic location is included in a predefined geographic area associated with the parking area; identifying an average parking time based on the length of time in each location data entry of the subset; identifying an average cost amount based on the transaction amount included in each transaction data entry of the subset; and identifying an estimated parking rate for the parking area based on the average parking time and cost.

### FIELD

The present disclosure relates to the generating of data correlations between parking metrics and transaction behavior and use thereof in estimation of parking capacity and parking metrics for a given area based on purchase data.

### BACKGROUND

In heavily urbanized areas, such as in dense cities like New York City, Washington, D.C., and Chicago, and at places where a significant amount of people may visit, such as large shopping malls, arenas, stadiums, and concert venues, the ability to find parking may be extremely limited. Because of the demand for parking, many of these places include significant parking structures or areas, and will often only allow parking for a fee, in an effort to both limit the number of parkers and also to take advantage of the need for parking.

Unfortunately, even with the addition of fees and extra parking structures, it may still be difficult and time consuming, and in some instances completely impossible, to find an open parking spot. In such instances, a driver may spend a significant amount of time looking for a parking spot in various locations, time which could have been better spent by parking further away from their destination and walking, or taking public transportation or other alternative forms of transportation that, due to parking constraints, would have been faster.

In an effort to assist parkers with finding available parking spaces, many parking structures have begun to use methods for determining how many spaces are available within the structure. In some instances, the parking structure may use sensors on each parking space to identify occupancy, while, in other instances, the movement of vehicles in and out of the parking structure may be tracked. Unfortunately, such information is only obtainable for parking structures, is often only available for a single parking structure and not for parking in an area as a whole, and is often unavailable for different forms of parking, such as street parking. In addition, such information is often only available if the person attempting to park physically visits the parking structure, which, if no spaces are available, may result in a wasted trip for the person, who must then spend additional time trying to find a parking space elsewhere.

Thus, there is a need for a technical solution where parking metrics for a geographic area as a whole may be identified, which may include available parking in the area that is not limited to specific parking structures. In addition, there is a need for a technical solution where the parking metrics may be identified without analysis of individual parking spaces or parking structures specifically, as such methods may require significant expenditure of resources and development of complicated technology. Accordingly, the identification of parking metrics based on transaction behavior, which may be identified via data correlations generated between parking metrics and transaction behavior, may provide for a technical solution to the assessment of parking capacity for a geographic area.

### SUMMARY

The present disclosure provides a description of systems and methods for generating data correlations between parking metrics and transaction behavior and estimates of parking metrics based thereon.

A method for generating data correlations between parking metrics and transaction behavior includes: storing, in a first database of a processing server, a plurality of parking data entries, wherein each parking data entry includes at least a geographic area, a time and/or date, and one or more parking metrics; storing, in a second database of the processing server, a plurality of transaction data entries, wherein each transaction data entry includes data related to a payment transaction including at least a plurality of data elements including at least a first data element configured to store a geographic location and a second data element configured to store a time and/or date; receiving, by a receiving device of the processing server, a data correlation request, wherein the data correlation request includes a specific geographic area and a plurality of time and/or date ranges; executing, by a processor of the processing server, a first query on the first database to identify, for each time and/or date range of the plurality of time and/or date ranges, a corresponding parking data entry where the included geographic area corresponds to the specific geographic area and where the included time and/or date is within the respective time and/or date range; executing, by the processor of the processing server, a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range; identifying, by the processor of the processing server, one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries; identifying, by the processor of the processing server, at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry; and transmitting, by a transmitting device of the processing server, the identified at least one data correlation in response to the received data correlation request.

A method for generating data estimates of parking metrics based on transaction behaviors includes: storing, in a first database of a processing server, a plurality of parking data correlations, wherein each parking data correlation includes at least one or more parking metrics and one or more correlated transaction behaviors; storing, in a second database of the processing server, a plurality of transaction data entries, wherein each transaction data entry includes data related to a payment transaction including at least a plurality of data elements including at least a first data element configured to store a geographic location and a second data element configured to store a time and/or date; receiving, by a receiving device of the processing server, a parking metric request, wherein the parking metric request includes at least a specific geographic area and a time and/or date range; executing, by a processor of the processing server, a first query on the second database to identify a subset of transaction data entries where the included first data element stores a geographic location within the specific geographic area and where the included second data element stores a time and/or date within the time and/or date range; identifying, by the processor of the processing server, one or more transaction behaviors based on at least a number of transaction data entries included in the identified subset of transaction data entries and data stored in one or more of the plurality of data elements included in each transaction data entry included in the identified subset of transaction data entries; executing, by the processor of the processing server, a second query on the first database to identify a parking data correlation where the included one or more correlated transaction behaviors corresponds to the identified one or more transaction behaviors; and transmitting, by a transmitting device of the processing server, at least the one or more parking metrics included in the identified parking data correlation in response to the received parking metric request.

A method for estimation of parking rates based on location and transaction data includes: storing, in a transaction database of a processing server, a plurality of transaction data entries, wherein each transaction data entry is a structured data set related to a payment transaction including at least a geographic location or merchant identifier, transaction time and/or date, and transaction amount; storing, in a location database of a processing server, a plurality of location data entries, wherein each location data entry is a structured data set related to a consumer geolocation including at least a geographic location, a location time and/or date, and a length of time; executing, by a querying module of the processing server, a query on the transaction database to identify a subset of transaction data entries where the included geographic location or merchant identifier are associated with a parking area; executing, by the querying module of the processing server, a query on the location database to identify a subset of location data entries where the included geographic location is included in a predefined geographic area associated with the parking area; identifying, by a determination module of the processing server, an average parking time based on the length of time included in each of the location data entries included in the identified subset of location data entries; identifying, by the determination module of the processing server, an average cost amount based on the transaction amount included in each of the transaction data entries included in the identified subset of transaction data entries; and identifying, by the determination module of the processing server, an estimated parking rate for the parking area based on at least the identified average parking time and identified average cost.

A system for generating data correlations between parking metrics and transaction behavior includes a first database, a second database, a receiving device, a processor, and a transmitting device of a processing server. The first database of a processing server is configured to store a plurality of parking data entries, wherein each parking data entry includes at least a geographic area, a time and/or date, and one or more parking metrics. The second database of the processing server is configured to store a plurality of transaction data entries, wherein each transaction data entry includes data related to a payment transaction including at least a plurality of data elements including at least a first data element configured to store a geographic location and a second data element configured to store a time and/or date. The receiving device of the processing server is configured to receive a data correlation request, wherein the data correlation request includes a specific geographic area and a plurality of time and/or date ranges. The processor of the processing server is configured to: execute a first query on the first database to identify, for each time and/or date range of the plurality of time and/or date ranges, a corresponding parking data entry where the included geographic area corresponds to the specific geographic area and where the included time and/or date is within the respective time and/or date range; execute a second query on the second database to identify, for each time and/or date range of the plurality of time and/or date ranges, a subset of transaction data entries where the geographic location stored in the included first data element is within the specific geographic area and where the time and/or date stored in the included second data element is within the respective time and/or date range; identify one or more transaction behaviors for each time and/or date range of the plurality of time and/or date ranges based on at least a number of transaction data entries included in the associated subset of transaction data entries and data stored in one or more of the plurality of data elements included in each transaction data entry included in the associated subset of transaction data entries; and identify at least one data correlation between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry. The transmitting device of the processing server is configured to transmit the identified at least one data correlation in response to the received data correlation request.

A system for generating data estimates of parking metrics based on transaction behaviors includes a first database, a second database, a receiving device, a processor, and a transmitting device of a processing server. The first database of a processing server is configured to store a plurality of parking data correlations, wherein each parking data correlation includes at least one or more parking metrics and one or more correlated transaction behaviors. The second database of the processing server is configured to store a plurality of transaction data entries, wherein each transaction data entry includes data related to a payment transaction including at least a plurality of data elements including at least a first data element configured to store a geographic location and a second data element configured to store a time and/or date. The receiving device of the processing server is configured to receive a parking metric request, wherein the parking metric request includes at least a specific geographic area and a time and/or date range. The processor of the processing server is configured to: execute a first query on the second database to identify a subset of transaction data entries where the included first data element stores a geographic location within the specific geographic area and where the included second data element stores a time and/or date within the time and/or date range; identify one or more transaction behaviors based on at least a number of transaction data entries included in the identified subset of transaction data entries and data stored in one or more of the plurality of data elements included in each transaction data entry included in the identified subset of transaction data entries; and execute a second query on the first database to identify a parking data correlation where the included one or more correlated transaction behaviors corresponds to the identified one or more transaction behaviors. The transmitting device of the processing server is configured to transmit at least the one or more parking metrics included in the identified parking data correlation in response to the received parking metric request.

A system for estimation of parking rates based on location and transaction data includes: a transaction database of a processing server configured to store a plurality of transaction data entries, wherein each transaction data entry is a structured data set related to a payment transaction including at least a geographic location or merchant identifier, transaction time and/or date, and transaction amount; a location database of a processing server configured to store a plurality of location data entries, wherein each location data entry is a structured data set related to a consumer geolocation including at least a geographic location, a location time and/or date, and a length of time; a querying module of the processing server configured to execute a query on the transaction database to identify a subset of transaction data entries where the included geographic location or merchant identifier are associated with a parking area, and execute a query on the location database to identify a subset of location data entries where the included geographic location is included in a predefined geographic area associated with the parking area; and a determination module of the processing server configured to identify an average parking time based on the length of time included in each of the location data entries included in the identified subset of location data entries, identify an average cost amount based on the transaction amount included in each of the transaction data entries included in the identified subset of transaction data entries, and identify an estimated parking rate for the parking area based on at least the identified average parking time and identified average cost.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the generation of data correlations between parking metrics and transaction behavior and use thereof in estimating parking metrics in accordance with exemplary embodiments.

FIG. 2 is a block diagram illustrating the processing server of FIG. 1 for the generation and use of data correlations between parking metrics and transaction behavior in accordance with exemplary embodiments.

FIG. 3 is a flow diagram illustrating a process for the generation of data correlations between parking metrics and transaction behavior and use thereof in estimation of parking metrics using the system of FIG. 1 in accordance with exemplary embodiments.

FIG. 4 is a flow chart illustrating an exemplary method for generating data correlations between parking metrics and transaction behavior in accordance with exemplary embodiments.

FIG. 5 is a flow chart illustrating an exemplary method for generating data estimates of parking metrics based on transaction behaviors in accordance with exemplary embodiments.

FIG. 6 is a block diagram illustrating a computer system architecture in accordance with exemplary embodiments.

FIG. 7 is a flow diagram illustrating a process for the processing of a payment transaction in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Generation and Use of Data Correlations Between Parking Metrics and Transaction Behaviors

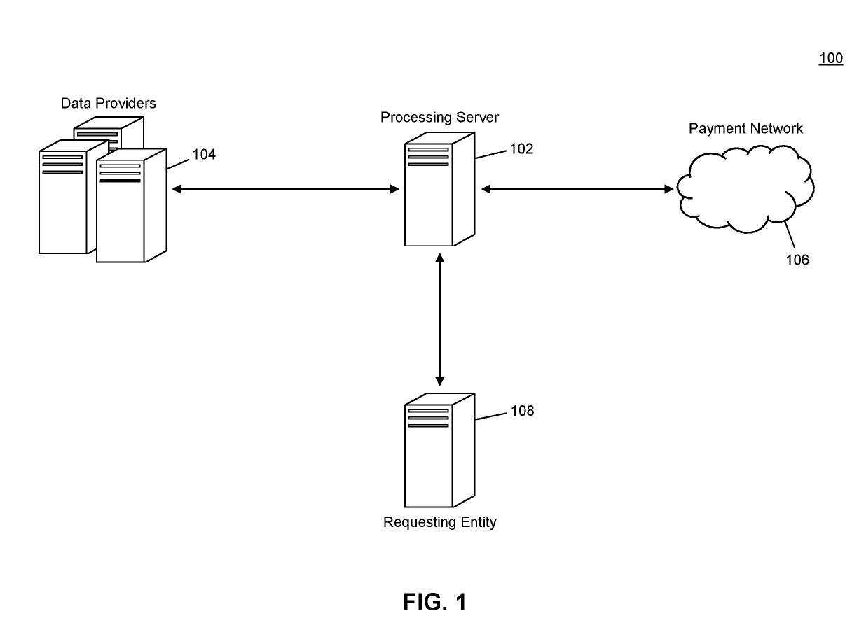

FIG. 1 illustrates a system 100 for the generation of data correlations between parking metrics for a geographic area and transaction behaviors based on transaction data therein, and use thereof in the estimation of parking metrics for a geographic area based on transaction behaviors.

The system 100 may include a processing server 102. The processing server 102, discussed in more detail below, may be configured to generate data correlations between parking metrics and transaction behaviors, including the generation of the transaction behaviors based on payment transaction data, and use of the generated data correlations in the estimation of parking metrics. The processing server 102 may be one or more computing systems specially configured to perform the functions disclosed herein, thereby comprising a special purpose computing system. The processing server 102 may be configured to receive and store parking metrics and parking data for one or more geographic areas, and receive and store transaction data for payment transactions in one or more geographic areas, and use these disparate data sets to generate data correlations between parking metrics and transaction behavior.

In the system 100, parking metrics and other parking data may be provided to the processing server 102 by one or more data providers 104. Data provider 104 may include governmental agencies, parking businesses, research agencies, survey firms, transportation agencies, and other data sources that may be configured to collect parking data and parking metrics to provide to the processing server 102. The data providers 104 may communicate with the processing server 102 via one or more suitable communication networks, which may include the Internet, cellular communication networks, local area networks, radio frequency, etc. Data signals may be superimposed with parking data and parking metrics by computing devices of the data providers 104, which may be electronically transmitted via the communication network to the processing server 102. The processing server 102 may receive the data signals and parse the data superimposed thereon to obtain the parking metrics and other parking data. The processing server 102 may store the data received from the data providers 104 in a data structure, wherein the stored data may be standardized for implementation in the systems and methods described herein.

As discussed in more detail below, the processing server 102 may store the parking metrics as standardized data sets in a database, which may be locally stored in the processing server 102 or stored in an external database and accessed remotely, such as via the same or an alternative communication network using data signals for communication. For example, in some embodiments, parking metrics may be stored in external data storage and accessed using one or more cloud computing techniques that will be apparent to persons having skill in the relevant art.

The data signals received by the processing server 102, from the data providers 104, may comprise data related to one or more entities which may be directly or indirectly associated with parking availability and parking services in one or more particular locations. In some embodiments, the data signals may comprise data related to parking of a geographic location (e.g., data related to parking garages; metered parking spaces; restaurants; entertainment venues; public transportation providers; and other area businesses and/or events that may affect parking availability in a given geographic area). The data signals may comprise geographic location data representative of the geographic location of entities that may affect parking availability or such geographic location data may be obtained subsequent or prior to entity-specific data. The data signals may also comprise additional data related thereto, e.g., location, parking capacity, rates (particularly for parking providing entities, etc.); hours of operation, store/business location capacity, turnover rate (e.g., in regard to restaurants), average amount of time spent by a consumer at location, etc. The data signals may comprise data representative of one-time or multiple-time events (e.g., a concert occurring on a specific data at a specific time in a specific venue). The data signals may comprise location (e.g., station location information, etc.), operating hours, capacity, average capacity for a given day/time/location, etc. for public transportation and other types of transportation means alternative to personal vehicles (e.g., ride share data, etc.).

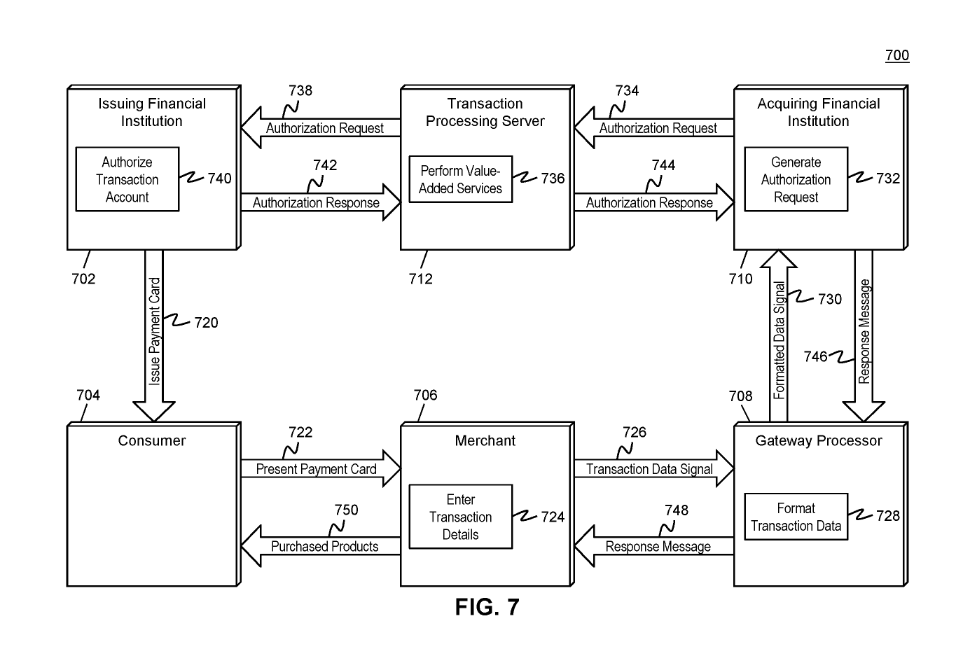

In embodiments, the processing server 102 may receive information related to an entity in response to an initial action by the processing server 102. In some embodiments, the processing server 102 may execute a process for acquiring additional information related to an entity/parking of an area by, for example, conducting an automated web search or communicating with a database which may store entity-related information (e.g., ticket warehouse; venue websites; restaurant reservations systems; entity-review-related websites and databases, etc.). In some embodiments, the processing server 102 may receive data submitted directly or indirectly from an entity device via a communications network. The data acquired by the processing server 102 may be aggregated and stored in one or several databases, wherein the database may include a plurality of data entries, each associated with one or more parking identifying information and various terms, as described above, that may be associated with the parking identifying information which may have a direct or indirect effect on parking availability in a parking location at a given time. In some instances, multiple data entries identifying parking locations may be grouped (e.g., all parking spaces within a neighborhood block may be assigned a value which collectively identifies the parking spaces within the neighborhood block, etc.) The system 100 may also include a payment network 106. The payment network 106 may be configured to process payment transactions and obtain transaction data associated thereto. Transaction data may include transaction amounts, transaction times and/or dates, geographic locations, merchant data, consumer data, offer data, reward data, loyalty data, product data, etc. As part of the processing of payment transactions, the payment network 106 may receive transaction messages. Transaction messages may be specially formatted data sets that are formatted based on one or more standards, such as the International Organization for Standardization's ISO 8583 standard. Transaction messages may include a plurality of data elements, each data element being configured to store data as set forth in the associated standard(s), such as data elements configured to store primary account numbers, merchant category codes, merchant identifiers, geographic locations, transaction amounts, transaction times, etc. Transaction messages may be communicated using specially configured infrastructure that utilizes specialized communication protocols, known to persons having skill in the art as “payment rails.” The payment rails may be specialized infrastructure specially configured for the secure transmission of transaction messages and other sensitive financial information, and may be access only via specialized computing systems and not by general purpose computers lacking the specialized programming required for communications with the payment rails infrastructure. Additional data regarding the processing of payment transactions, including the use of payment networks 106 and transaction messages, is discussed in more detail below with respect to the process 700 illustrated in FIG. 7.

The processing server 102 may be configured to obtain transaction data from the payment network 106. In some embodiments, the payment network 106 may provide the processing server 102 with transaction messages for a plurality of payment transactions. In such embodiments, the processing server 102 may be specially configured to communicate with the payment network 106 using the payment rails and be configured to receive transaction messages, formatted based on the associated standards, using the specialized infrastructure and protocols of the payment rails. In some instances, the processing server 102 may electronically transmit a data signal to the payment network 106 via the payment rails or an alternative communication network requesting the transaction messages. In other instances, the payment network 106 may periodically transmit transaction messages to the processing server 102, where the period may be established by the processing server, payment network 106, or suitable criteria, such as based on the needs of the processing server 102 in providing the data. The processing server 102 may be configured to parse the received transaction messages to obtain the data stored in the data elements included therein. In other embodiments, the payment network 106 may superimpose data signals with transaction data for payment transactions, which may be transmitted to the processing server 102 using other suitable communication networks, such as the Internet or cellular communication networks. In some instances, transaction data transmitted to the processing server 102 for use in performing the functions discussed herein may have some data removed. For example, the data stored in some data elements may be removed from the transaction messages prior to transmission or superimposition, such as account numbers, consumer data, or other data that may not be used by the processing server 102 or may be removed to protect consumer privacy or security.

The processing server 102 may be configured to generate data correlations between parking metrics and transaction behaviors. For a given geographic area and time and/or date range, the processing server 102 may execute queries on databases storing transaction data and parking metrics and identify transaction data and parking metrics for the geographic area and the time and/or date range. The processing server 102 may identify transaction behaviors for the geographic area and time and/or date range based on the identified transaction data. Transaction behaviors may include, for example, transaction frequency, parking purchase frequency, transportation purchase frequency, number of transaction, transaction merchant types, average ticket amount, propensity to spend on parking, parking and transportation spend ratios, etc. The transaction behaviors may be based on the transaction data for one or more payment transactions conducted in the geographic area during the time and/or date range. For instance, to identify parking purchase frequency, the processing server 102 may identify transaction data for payment transactions where a merchant category code indicating a parking vendor is included, which may signify a transaction for the purchase of parking, and may identify the frequency of such transactions among all payment transactions in the geographic area during the time and/or date range. The processing server 102 may be configured to aggregate and/or tag events that may be related to a geographic areas' parking capacity, either directly or indirectly. For instance, the processing server 102 may tag, or otherwise demarcate, directly related events such as payments at parking garages based upon geography/time or payments at meter parking based upon geography/time, etc. The processing server 102, may tag, for example, indirectly related events such as purchases for tickets of a particular venue (remotely or on-location purchases), dinner-related purchases of a particular geographic area (e.g., transactions conducted at all restaurants on block A, etc.); transactions conducted at a mall or other group of, or individual, business location; transactions conducted at a public transportation location or related to such a location; etc. The processing server 102 may be configured to assign values to various events, wherein the values may represent a significance score based upon one or more characteristics of the events (e.g., proximity to area of concern, direct/indirect nature of event, etc.)

The processing server 102 may then identify data correlations between the transaction behaviors for the geographic area and parking metrics over several time and/or date ranges. For example, the processing server 102 may identify that when the parking purchase frequency is at a specific level, the available parking capacity is at a specific level. In another example, the processing server 102 may identify a data correlation between parking cost and amount of spending or average ticket price for parking-related transactions. In some instances, data correlations may be identified for a specific geographic area. In some cases, the processing server 102 may be configured to compare data correlations across multiple geographic areas. For instance, the processing server 102 may identify that the data correlations are the same for geographic areas of different sizes or demographics if the transaction behavior is the same, or may identify that two different areas with the same transaction behavior may have different data correlations, such as due to extraneous factors like the availability of public transportation. In some instances, such identifications may be used in the estimation of parking metrics, as discussed below.

The processing server 102 may group data correlations into location-associated segments automatically from time-to-time or in response to the receipt of an instruction for grouping and store such correlated data in one or several databases. The processing server 102 may update the data correlations at predetermined time intervals (e.g., once an hour, once a day, once a minute, every 3 minutes, etc.) based upon newly received data that may affect the location associated segments. The processing server 102 may update the data correlations each time newly received data affecting the location associated segments is received (e.g., transaction data associated with an area entity, etc.).

In embodiments, the processing server 102 may receive information related to parking in a location based upon user survey data. For instance, a survey may be provided to a mobile device of a user, and displayed thereby to the user for user-input. The user may be prompted to provide responses to a series of questions related to parking (e.g., “did you pay for parking?” etc.). The survey notification may be provided to the consumer automatically, e.g., based upon a detection of a geographic location of the mobile device, in response to an electronic transaction associated with the mobile device (e.g., the mobile device is associated with a card funding an electronic transaction received from a particular point of sale device, etc.). Various other methods and systems by which a survey may be provided and received by the processing server 102 may also be implemented to receive parking-related information and store the information as useful data. In some embodiments, the processing server 102 may receive location related information (e.g. via GPS of a mobile device or vehicle, etc.). The location related information may be collected, e.g., by a mobile application running on a mobile device of a driver, from a vehicle system associated with the driver, etc. The location related information may be analyzed to determine whether the device from which the location information originated is operating in a manner which indicates parking is unavailable. For instance, the location-related data may be analyzed to determine if a device is repeatedly circling an area (such as a neighborhood block or groups of blocks, if a device has attempted entry into a parking structure, entered/exited a structure within a predetermined period of time, etc.). The processing server 102 may store the information for use in analytics performed on the data to determine parking availability or formulate a prediction of parking availability in a specified area.

The system 100 may also include a requesting entity 108. The requesting entity 108 may be an entity requesting data correlations between parking metrics and transaction data and/or the estimation of parking metrics based on transaction data. The requesting entity 108 may be, for instance, a data provider 104, the payment network 106, or other suitable entity, such as a governmental agency researching the parking situation in a municipality, a transportation company evaluating transportation routes and fares, a parking company researching for parking fees and the expansion or building of parking structures. The requesting entity 108 may be a device operated by any of such entities. In some instances, the estimation of parking metrics may be made available to a person looking to park, such as via an application program of a mobile communication device, where the person may view the parking capacity for a geographic area estimated by the processing server 102 prior to visiting the area to establish a plan for how to arrive to the area and, if necessary, where to go for parking.

The requesting entity 108 may electronically transmit a data signal to the processing server 102 that is superimposed with at least a geographic area and a time and/or date range for which parking metrics are requested. The processing server 102 may parse the data signal for the geographic area and time and/or date range, and identify transaction data for payment transactions processed in the geographic area during the time and/or date ranged based on the data included therein. The processing server 102 may generate transaction behaviors for the geographic area and time and/or date range using the identified transaction data. Once the transaction behaviors are generated, the processing server 102 may execute a query on a database to identify data correlations between the generated transaction behaviors and parking metrics. The correlated parking metrics may then be used to estimate parking metrics for the geographic area at the time and/or date. The processing server 102 may generate a data signal superimposed with the estimated parking metrics, which may be electronically transmitted to the requesting entity 108.

In some embodiments, the transaction data identified by the processing server 102 for use in the estimation of the parking metrics may be for a similar time and/or day, but at a different time and/or date, and/or for similar geographic areas at the same or a similar time and/or day. For example, the requesting entity 108 may be requesting estimated parking capacity for a Saturday at 8:00 PM. In such an instance, the processing server 102 may identify transaction behavior for the geographic area at previous Saturdays around 8:00 PM, or for Saturdays at 8:00 PM during the same time of year in the same or similar geographic areas, or for weekends at 8:00 PM, or for evenings at 8:00 PM having the same weather (e.g., based on data available via data providers 104), etc. In such instances, the transaction data may be used as an estimate of the transaction data for the time and/or date requested, such as in instances where the requesting entity 108 may request an estimate of parking capacity at the present time, when transaction data for the present time may be unavailable.

By generation transaction behaviors at various time and/or date ranges for geographic areas and correlating the behaviors with parking metrics, the processing server 102 may be configured to provide accurate estimations of parking capacity and parking metrics without the need to technologically update parking structures and systems and in a way that is more efficient and more effective than traditional methods for identifying parking capacity. By using transaction behavior, the processing server 102 may identify parking metrics for a geographic area where there is currently no method available for evaluating parking metrics. As a result, the system 100 discussed herein may provide for a significant technological improvement to the generation of data correlations between transaction behaviors and parking metrics and use thereof in the estimation of parking metrics for a geographic area.

In some embodiments, the processing server 102 may be configured to estimate the parking rate for one or more parking areas based on historical transaction data, as well as geographic location data obtained from individuals that park in the parking areas. In such embodiments, the processing server 102 may obtain geographic location data associated with a plurality of individuals (e.g., or computing devices associated therewith) that have parked in a parking area. The geographic location data may include at least a geographic location (e.g., at or near a parking area), a time and/or date when the associated individual and/or their computing device was at (e.g., or entered or exited) the geographic location, and a length of time that the associated individual and/or their computing device was at the geographic location. In some instances, the length of time may be representative of the time period between first arriving at the geographic location and then leaving the geographic location. For example, an individual may enter a parking structure to park, then leave and travel to other locations, before returning to the parking structure to retrieve their vehicle and exit the structure. In such instances, the geographic location of the individual may be outside of the parking structure during the length of time, but the length of time may still be representative of the time spent parking at the parking structure.

In some instances, the processing server 102 may receive geographic location data from data providers 104, such as cellular network providers, geographic tracking agencies, etc. In other instances, the processing server 102 may be configured to identify geographic locations of individuals via associated computing devices. For instance, an individual may install an application program on a computing device configured to obtain parking rate estimates from the processing server 102 and, as part of the application program, may opt-in to the reporting of the geographic location to the processing server 102. The geographic location of a computing device may be identified using any suitable method, such as cellular network triangulation, the global positioning system, detection via local area networks, etc. Any suitable type of computing device may be used, such as a tablet computer, laptop computer, notebook computer, cellular phone, smart phone, smart watch, wearable computing device, implantable computing device, etc.

The processing server 102 may identify the average amount of time that an individual spends at a parking area based on the geographic location data obtained for the parking area. The processing server 102 may also identify the average transaction amount for payment transactions conducted that are associated with the parking area, such as based on the geographic location, merchant identifier, merchant category code, or other data included in transaction messages or other transaction data. The processing server 102 may then estimate the parking rate for the parking area based on the amount of time parked and the amount paid for the parking. In some instances, the processing server 102 may match payment transactions to location data using times and dates, which may increase accuracy for the estimate. For example, transaction data entries may be matched to parking data where the transaction was conducted within a predetermined period of time (e.g., five minutes) from leaving the parking area. The processing server 102 may then estimate the rate for that transaction (e.g., based on the amount paid and the length of time parked), and estimate an overall average rate for the parking area using all of the estimated rates.

In some cases, the processing server 102 may match location data to payment transactions using identifying data, such as an account identifier. An account identifier may be a unique value associated with a transaction account, computing device, or individual, which may be used in identification thereof. In such cases, location data received by the processing server 102 may include an account identifier associated with the individual and/or computing device to which the location data corresponds, such as a media access control address of the computing device. Transaction data for one or more transactions may also include a media access control address, such as for a computing device used to conduct the payment transaction to pay for parking (e.g., done via an electronic wallet, application program, etc.). The processing server 102 may thus match location data to payment transactions to estimate parking rates for a parking area based on the length of time and amount paid, and estimate an overall parking rate for the area based on each of the parking rates.

In some cases, the processing server 102 may identify parking rates for multiple periods of time. For example, as discussed above, the processing server 102 may be requested (e.g., by a requesting entity 108, such as an individual using a computing device) to estimate a parking rate for a Saturday at 8 PM. The processing server 102 may then estimate the parking rate for the parking area as discussed herein, but may limit the transaction data and location data used to transactions conducted and locations obtained at or around 8 PM on a Saturday. The processing server 102 may identify parking rates for multiple periods of time to determine when parking rates may change and may differ, which may be associated with the parking area's parking metrics.

In some instances, the processing server 102 may take estimated parking rates into account when providing recommendations to an individual. For instance, a requesting entity 108 may request parking availability information in a geographic area, as discussed above. The processing server 102 may estimate the parking availability for the indicated geographic area and nearby geographic areas, and may also estimate the parking rate for parking in the geographic area and the nearby areas. The processing server 102 may then return the estimated parking availability and rate for the indicated geographic area, but may also include an estimated parking availability and rate for the nearby areas, particularly if the availability or rate may be more favorable. For example, the processing server 102 may inform the requesting entity 108 that parking may be found for half the cost in a parking structure only half a mile from the indicated area. In some cases, a requesting entity 108 may provide weights for considerations used in providing recommendations. For instance, the requesting entity 108 may weight the importance of location, availability, and cost, which may be taken into account by the processing server 102 in suggesting a parking area. For example, the requesting entity 108 may value cost above geographic location, and may be recommended a parking area over a mile from the indicated area if the cost is sufficiently less than parking in the indicated area.

The processing server 102 may therefore provide accurate estimates of the parking rate in a parking area using historical transaction and location data, including transaction and location data that may be anonymized and not associated with any individual, computing device, transaction account, or vehicle, to provide for accurate estimates while maintaining individual privacy. In addition, the estimation of parking rates may be combined with other metrics discussed herein to provide beneficial recommendations to individuals regarding parking, by estimating the cost of parking in addition to other metrics, such as availability.

### Processing Server

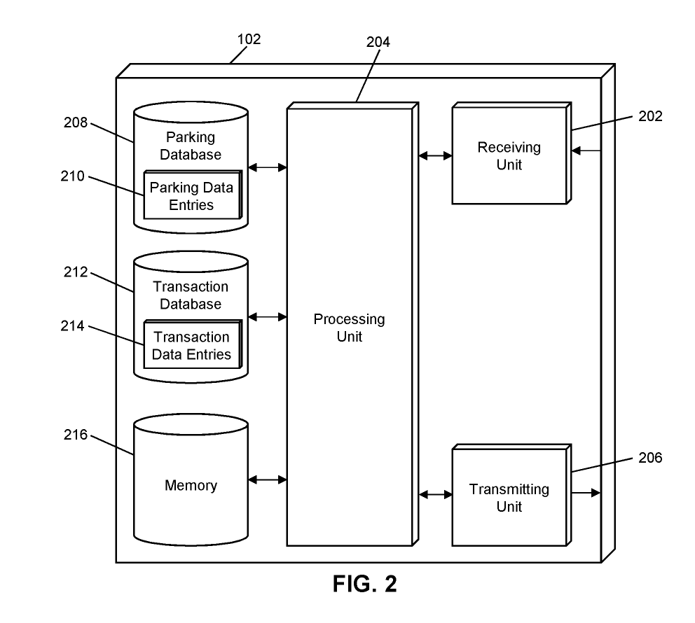

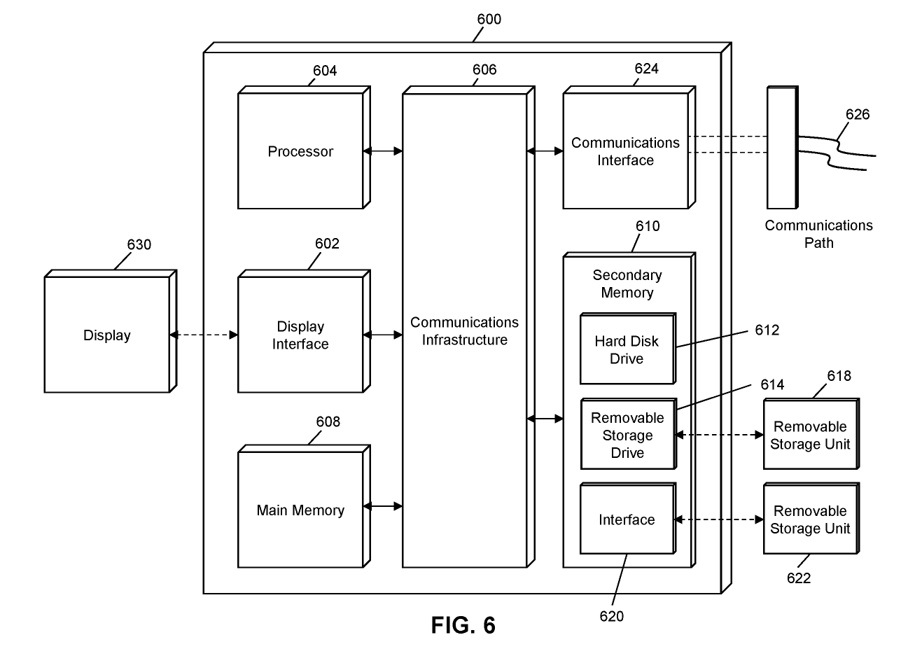

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. In some embodiments, the receiving unit 202 may be configured to receive data over the payment rails, such as using specially configured infrastructure associated with payment networks 106 for the transmission of transaction messages that include sensitive financial data and information. In some instances, the receiving unit 202 may also be configured to receive data from data providers 104 and requesting entities 108, and other entities via alternative networks, such as the Internet. In some embodiments, the receiving unit 202 may be comprised of multiple units, such as different receiving units for receiving data over different networks, such as a first receiving unit for receiving data over payment rails and a second receiving unit for receiving data over the Internet. The receiving unit 202 may receive electronically data signals that are transmitted, where data may be superimposed on the data signal and decoded, parsed, read, or otherwise obtained via receipt of the data signal by the receiving unit 202. In some instances, the receiving unit 202 may include a parsing module for parsing the received data signal to obtain the data superimposed thereon.

The receiving unit 202 may be configured to receive data signals electronically transmitted by the data providers 104 superimposed with data comprising parking metrics, which may include parking metrics for a plurality of date and/or time ranges and geographic areas. The receiving unit 202 may also be configured to receive data signals electronically transmitted by the payment network 106 superimposed with data comprising transaction data for a plurality of payment transactions. In some embodiments, the transaction data may be comprised in transaction messages, which may be electronically transmitted by the payment network 106 and received by the receiving unit 202 using the payment rails. Transaction data received by the receiving unit 202 may be for a plurality of payment transactions and include at least a time and/or date and geographic area for the payment transaction, as well as additional data suitable for use in performing the functions discussed herein, such as merchant category data. The receiving unit 202 may also receive data signals electronically transmitted by data providers 104, including computing devices associated with individuals, that may be superimposed or otherwise encoded with location data regarding geographic locations associated with parking in one or more parking areas.

The processing server 102 may also include one or more communication modules configured to transmit data between modules, engines, databases, units, memories, and other components in the processing server 102. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc.

The processing server 102 may also include a processing unit 204. The processing unit 204 may be configured to perform the functions of the processing server 102 discussed herein as will be apparent to persons having skill in the relevant art. In some embodiments, the processing unit 204 may include and/or be comprised of a plurality of engines and/or modules specially configured to perform one or more functions of the processing unit 204. As used herein, the term “module” may be software or hardware particularly programmed to receive an input, perform one or more processes using the input, and provide an output. The input, output, and processes performed by various modules will be apparent to one skilled in the art based upon the present disclosure. For example, the processing unit 204 may include a querying module configured to query databases included in the processing server 102 to identify information stored therein. In some instances, the processing unit 204 may include a parsing module or engine configured to parse data from data signals electronically received by the receiving unit 202, an encryption module or engine configured to decrypt received data or data signals or to encrypt data or data signals received or transmitted by the processing server 102, and any other modules suitable for performing the functions discussed herein. The processing unit 204 may also include a determination module, as discussed in more detail below.

The processing server 102 may also include a parking database 208. The parking database 208 may be configured to store a plurality of parking data entries 210 using a suitable data storage method and schema. Each parking data entry 210 may be a standardized data set configured to store at least a geographic area, a time and/or date, and one or more parking metrics. The one or more parking metrics may be parking metrics for the associated geographic area and time and/or date and may include, for instance, parking capacity, parking availability, parking search time, and parking cost. The geographic area may be represented using any suitable type of geographic representation, such as zip codes, postal codes, street addresses, latitude and longitude, municipalities, etc. In some instances, the parking metrics may also include parking rate data as estimated by the processing unit 204 using the methods discussed herein.

The processing server 102 may also include a transaction database 212. The transaction database 212 may be configured to store a plurality of transaction data entries 214 using a suitable data storage method and schema. Each transaction data entry 214 may include data related to a payment transaction including at least a transaction time and/or date and a geographic location. In some instances, a transaction data entry 214 may further include a merchant category code or additional transaction data, such as merchant data, point of sale data, consumer data, product data, transaction amount, etc. In some embodiments, each transaction data entry 214 may be or comprise a transaction message formatted pursuant to one or more standards, where the data included therein may be stored in data elements configured to store data as set forth in the one or more standards. For example, the transaction data entries 214 may be transaction messages having a first data element configured to store a geographic location and a second data element configured to store a time and/or date.

In some embodiments, the processing server 102 may also include a location database (not illustrated). The location database may be configured to store a plurality of location data entries using a suitable data storage method and schema. Each location data entry may include data related to a consumer geolocation including at least a geographic location, a location time and/or date, and a length of time. In some instances, the location data entry may be directly related to consumer geolocation with respect to parking, such as where the geographic location may correspond to a parking area and where the length of time represents a length of time parked in the corresponding parking area.

The processing unit 204 (e.g., a querying module or engine included therein) may be configured to execute queries on the parking database 208 and transaction database 212 to identify data included therein. For instance, the processing unit 204 may execute a first query on the parking database 208 to identify a parking data entry 210 where the included geographic area and time and/or date correspond to a specific geographic area and time and/or date range (e.g., as parsed from a request from the requesting entity 108 received by the receiving unit 202) and may execute a second query on the transaction database 212 to identify transaction data entries 214 where the included geographic area and time and/or date correspond to the specific geographic area and time and/or date range. The querying module of the processing unit 204 may also be configured to execute queries on the transaction database 212 and location database to identify subsets of transaction data entries 214 and location data entries, respectively, associated with a parking area based on the included geographic locations. In some instances, the querying module may execute queries to identify transaction data entries 214 and/or location data entries further based on account identifiers included therein.

The processing unit 204 (e.g., an analytic module or engine included therein) may be further configured to generate transaction behaviors for the identified transaction data entries 214 based on the transaction data included therein, such as transaction frequency, parking purchase frequency, transportation purchase frequency, number of transaction, transaction merchant types, etc. As used herein, the term “module” denotes the software and/or hardware configured to receive a specified input, perform a process thereon, and execute an output based upon the process performed by the module.

The processing unit 204 (e.g., a correlation module or engine included therein) may also be configured to generate data correlations between parking metrics and transaction behaviors based on the parking metrics and transaction behaviors for one or more geographic areas at a plurality of date and/or time ranges. The processing unit 204 (e.g., an estimation module or engine included therein) may be further configured to estimate parking metrics for a geographic area at a date and/or time based on transaction behaviors generated for the same or a similar date and/or time.

The processing unit 204 (e.g., via an analyzing module) may implement standard analytical methods to determine factors predictive of parking capacity (e.g., regression, correlation, decision trees, clustering, etc.). The processing unit 204 receive as input one or more of parking metrics data, transaction data, user device data (e.g., indicative of location of user/car, indicative of time device left user home to time of a user transaction (which may be associated via the transaction database, etc.). The analyzing module may output conclusions indicative of parking situations of given areas. The conclusion may be output and transmitted to a user device, upon which the conclusion may be displayed. The conclusion may be displayed as text or an illustration (e.g., as a chart, map, etc.). The conclusion may be superimposed upon, e.g., a map, wherein the appearance of the map may be altered (e.g., if parking is unlikely to be available, a map may change color, a symbol may be imposed on the map, etc.). The conclusion may be based on data provided by the requesting entity 108 or other entity requesting the conclusion, and may also take into account the parking metrics for the given areas, such as estimated availability and rate, and may also utilize weights provided by the requesting entity, as applicable.

The processing unit 204 of the processing server 102 may also include a determination module. The determination module may receive data as input, may make one or more determinations based thereon, and may output the determination(s) to another module or engine of the processing unit 204 or processing server 102. The determination module may be configured to identify an average parking time for a parking area based on the length of time included in location data entries identified for the parking area using the included geographic location. In some instances, average parking times may be identified for a plurality of different times and/or dates, such as an average parking time for various times of day for each day of the week and/or specific dates and times during the year, such as for special events or holidays. The determination module may also be configured to identify an average parking cost for a parking area based on the transaction amount included in transaction data entries 214 associated with the parking area as based on the included geographic location, merchant identifier, or other identifying information. In some instances, the determination module or querying module may match transaction data entries 214 to location data entries based on account identifiers or time and/or date data. The determination module may also be configured to determine an estimated parking rate for a parking area based on the identified average parking times and average parking costs. In cases where parking times and costs may be identified for a plurality of times and/or dates and/or matched sets of location data entries and transaction data entries 214, the determination module may identify an overall estimated parking rate based on the parking rates estimated for each of the plurality of times and/or dates or matched sets, as applicable.

The processing server 102 may further include a transmitting unit 206. The transmitting unit 206 may be configured to transmit data over one or more networks via one or more network protocols. In some embodiments, the transmitting unit 206 may be configured to transmit data over the payment rails, such as using specially configured infrastructure associated with payment networks 106 for the transmission of transaction messages that include sensitive financial data and information, such as identified payment credentials. In some instances, the transmitting unit 206 may be configured to transmit data to data providers 104 and requesting entities 108, and other entities via alternative networks, such as the Internet. In some embodiments, the transmitting unit 206 may be comprised of multiple units, such as different transmitting units for transmitting data over different networks, such as a first transmitting unit for transmitting data over the payment rails and a second transmitting unit for transmitting data over the Internet. The transmitting unit 206 may electronically transmit data signals that have data superimposed that may be parsed by a receiving computing device. In some instances, the transmitting unit 206 may include one or more modules for superimposing, encoding, or otherwise formatting data into data signals suitable for transmission.

The transmitting unit 206 may be configured to transmit data requests to the data providers 104 and payment networks 106, such as to request parking data or transaction data for use in performing the functions discussed herein. In some embodiments, data requests may be transmitted separately from requests for data received by the receiving unit 202. In other embodiments, the transmitting unit 206 may transmit data requests for data for use in estimating parking metrics based on a received data request, such as for requesting transaction data for payment transaction at a specific date and/or time for which estimated parking metrics are requested. The transmitting unit 206 may also be configured to electronically transmit data signals to the requesting entity 108 superimposed with estimated parking metrics, such as in response to a request for parking metrics electronically transmitted by the requesting entity 108 and received by the receiving unit 202.

The processing server 102 may also include a memory 216. The memory 216 may be configured to store data for use by the processing server 102 in performing the functions discussed herein. The memory 216 may be configured to store data using suitable data formatting methods and schema and may be any suitable type of memory, such as read-only memory, random access memory, etc. The memory 216 may include, for example, encryption keys and algorithms, communication protocols and standards, data formatting standards and protocols, program code for application programs, rules and algorithms for generating transaction behaviors, and other data that may be suitable for use by the processing server 102 in the performance of the functions disclosed herein as will be apparent to persons having skill in the relevant art.

In an example embodiment, a user device storing an application configured to communicate with the processing server 102 may initiate a communication with the processing server 102. For instance, a user may input a selection of an area (e.g., by touching a display of an area on a map displayed by the application, by inputting or selecting from a list a neighborhood, street, block range, etc.). The user device may transmit the user selection to the processing server 102. The processing server may identify, in one or more databases, parking-related data and/or analytical results of the processing server 102 for the area identified by the user selection. The processing server may cause the parking-related analysis/data to be transmitted to the user device for display thereon. The user may view the result provided by the processing server visually, via the application, (e.g., as text “search time for parking is 15 minutes”, an icon superimposed on a map displayed by the device, etc.). In instances where parking rate estimates may be identified, the processing server 102 may identify historical geographic location and transaction data for the user-selected area and estimate a parking rate based thereon, which may be transmitted to the user device for display.

### Process for Generating Data Correlations Between Parking Metrics and Transaction Behaviors

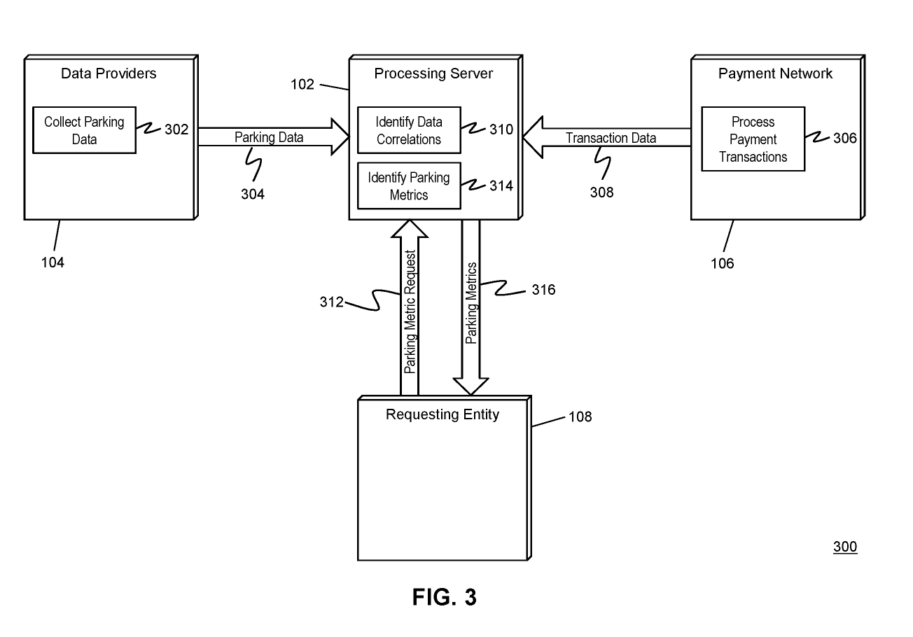

FIG. 3 illustrates a process 300 for the generation of data correlations between parking metrics and transaction behaviors in the system 100 and use thereof in the estimation of parking metrics for geographic area at a time and/or date based on transaction behaviors.

In step 302, the data providers 104 may collect parking data. The parking data may include parking metrics for one or more geographic areas at a plurality of times and/or dates. Parking data may be collected via surveys, crowdsourcing, physical examination, data analysis, and any other method suitable for the collection of data associated with parking in a geographic area. In some instances, parking data may include transportation data, such as related to public transportation and/or non-public forms of transportation, such as private vehicle data. In step 304, the data providers 104 may electronically transmit a data signal superimposed with the collected parking data to the processing server 102. The receiving unit 202 of the processing server 102 may receive the data signal and the receiving unit 202 or processing unit 204 of the processing server 102 may parse the received data signal to obtain the parking data superimposed thereon, which may be stored in the parking database 208. In some embodiments, data providers 104 may also provide location data to the processing server 102. Location data may include geographic location data identified for individuals, computing devices, and/or vehicles, and may include a geographic location, a time and/or date when the geographic location was identified (e.g., or arrived at or departed the geographic location), and a length of time at the geographic location (e.g., or between arrival and departure from the geographic location). In some such embodiments, the data providers 104 may be computing devices and may be configured to collect and report geographic locations to the processing server 102 using traditional methods and systems.

In step 306, the payment network 106 may process a plurality of payment transactions using traditional methods and systems that will be apparent to persons having skill in the relevant art. As part of the processing of payment transactions, the payment network 106 may receive and store transaction data for the payment transactions. In some embodiments, the transaction data may be stored in specially formatted transaction messages, in data elements included therein configured to store data as set forth in associated standards. In step 308, the payment network 106 may transmit the transaction data to the processing server 102. In some embodiments, the transaction data may be superimposed on data signals electronically transmitted by the payment network 106 using standard communication networks. In other embodiments, the transaction messages containing the transaction data may be transmitted to the processing server 102 using the payment rails, such as by electronically transmitting the transaction messages through the specialized infrastructure associated with the payment network 106 for communication therewith. In each embodiment, the receiving unit 202 of the processing server 102 may receive the transaction data, which may be stored in the transaction database 212.

In step 310, the processing unit 204 of the processing server 102 may identify data correlations between the parking data and transaction behaviors. Step 310 may include the execution of queries by the processing unit 204 of the parking database 208 and transaction database 212 to identify parking and transaction data for a geographic area at a plurality of date and/or time ranges, the generation of transaction behaviors for the geographic area at each of the plurality of date and/or time ranges based on the associated transaction data, and the generation of data correlations for the geographic area between the parking metrics and transaction behaviors at the various time and/or date ranges. In some embodiments, step 310 may also include the identification of correlations between transaction data and geographic location data, such as matching performed by the processing unit 204 to match transaction data entries 214 and location data entries via geographic location, account identifier, and/or time and/or date.

In step 312, the requesting entity 108 may electronically transmit a data signal to the processing server 102 superimposed with a parking metric request. The parking metric request may include at least a geographic area and a time and/or date for which parking metrics are requested. In some instances, the parking metric request may include one or more parking metrics that are specifically requested, such as specifying that parking availability for the geographic area at the time and/or date and an estimated parking rate are requested. The receiving unit 202 of the processing server 102 may receive the data signal, which may be parsed to obtain the parking metric request and data included therein.

In step 314, the processing unit 204 of the processing server 102 may identify an estimate of parking metrics in response to the received request. The estimation may include the execution of a query on the transaction database 212 to identify transaction data entries 214 for the geographic area at the specified time and/or date or a similar time and/or date, the generation of transaction behaviors using the identified transaction data entries 214, and the identification of data correlations that include the generated transaction behaviors. The parking metrics that are correlated with the generated transaction behaviors may thereby be identified by the processing unit 204 as estimates for parking metrics for the specified geographic area and time and/or date included in the parking metric request. In instances where an estimated parking rate may be requested, the determination module of the processing unit 204 may identify an estimated parking rate for the specified geographic area based on average parking times and parking costs for the specified geographic area using the previously identified correspondences. In instances where the parking metrics may be specified for a time and/or date, the estimated parking rate may be determined from corresponded location data entries and transaction data entries 214 at or around the specified time and/or date. In step 316, the transmitting unit 206 of the processing server 102 may electronically transmit a data signal superimposed with the identified parking metrics to the requesting entity 108.

In an example, the requesting entity 108 may be an individual utilizing a mobile device, such as a smart phone, to request an estimation of parking capacity near a geographic location they plan to visit. For instance, the individual may have a dinner reservation and is deciding between parking on the street near the restaurant, parking in a nearby parking garage, or taking public transportation. The parking metric request may include a request for parking metrics at the geographic location (e.g., near the restaurant) for the date and time of the reservation. The requested parking metrics may include, for instance, estimated parking capacity and estimated time to locate a parking space in the geographic area near the location at that date and time. The processing server 102 may identify and return the requested parking metrics, which the individual may then use to make a determination as to how to get to their destination. For instance, the processing server 102 may estimate that street parking will be near 100% capacity, while the parking garage will have a 70% capacity with a low time to find a parking space. In such an instance, the individual may decide to drive, and to head straight for the parking garage rather than attempt to find street parking. In some cases, the processing server 102 may also provide estimated parking rates using the methods discussed herein, and may provide such data to the individual when returning the requested parking metrics. In such cases, the individual may be influenced by the estimated cost of parking in each of the areas.

### Exemplary Method for Generating Data Correlations Between Parking Metrics and Transaction Behavior

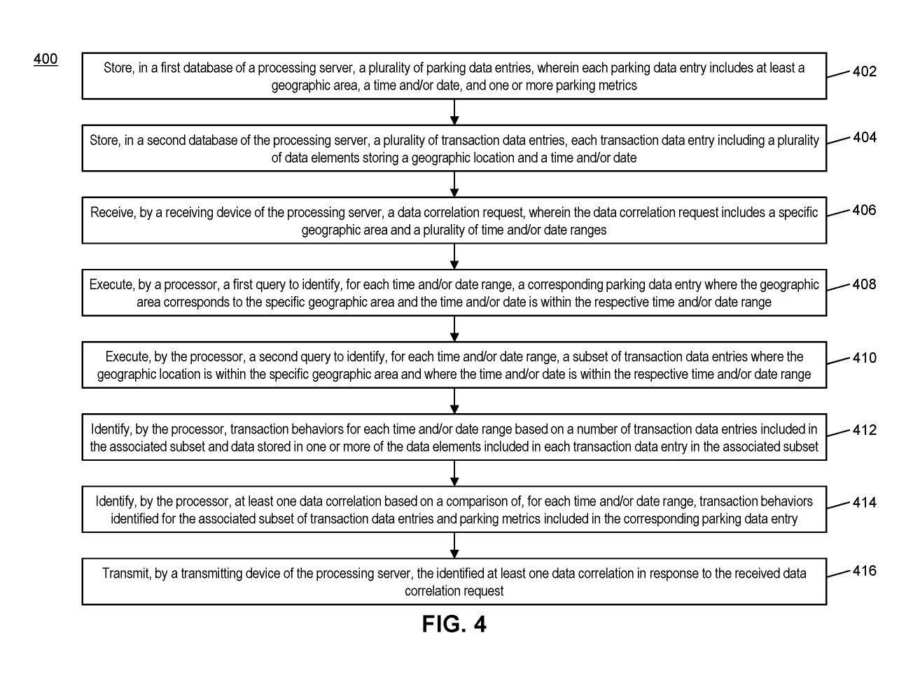

FIG. 4 illustrates a method 400 for the generation of data correlations between parking metrics for a geographic area and transaction behavior based on payment transactions in the geographic area.

In step 402, a plurality of parking data entries (e.g., parking data entries 210) may be stored in a first database (e.g., parking database 208) of a processing server (e.g., the processing server 102), wherein each parking data entry includes at least a geographic area, a time and/or date, and one or more parking metrics. In step 404, a plurality of transaction data entries (e.g., transaction data entries 214) may be stored in a second database (e.g., transaction database 212) of the processing server, wherein each transaction data entry includes a plurality of data elements storing a geographic location and a time and/or date.

In step 406, a data correlation request may be received by a receiving device (e.g., the receiving unit 202) of the processing server, wherein the data correlation request includes a specific geographic area and a plurality of date and/or time ranges. In step 408, a first query may be executed by a processor (e.g., the processing unit 204) of the processing server on the first database to identify, for each time and/or date range, a corresponding parking data entry where the geographic area corresponds to the specific geographic area and the time and/or date is within the respective time and/or date range.

In step 410, a second query may be executed by the processor of the processing server on the second database to identify, for each time and/or date range, a subset of transaction data entries where the geographic location stored in the first data element is within the specific geographic area and where the time and/or date stored in the included second data element is within the respective time and/or date range. In step 412, transaction behaviors for each time and/or date range may be identified by the processor based on a number of transaction data entries included in the associated subset and data stored in one or more of the data elements included in each transaction data entry in the associated subset.

In step 414, at least one data correlation may be identified by the processor of the processing server between transaction behaviors and parking metrics based on a comparison of, for each time and/or date range of the plurality of time and/or date ranges, the one or more transaction behaviors identified for the associated subset of transaction data entries and the one or more parking metrics included in the corresponding parking data entry. In step 416, a transmitting device (e.g., the transmitting unit 206) of the processing server may transmit the identified at least one data correlation in response to the received data correlation request.

In one embodiment, each transaction data entry may further include a third data element configured to store a merchant category identifier, and the one or more transaction behaviors may be further based on data stored in the third data element in each transaction data entry included in the associated subset of transaction data entries. In a further embodiment, the merchant category identifier may be indicative of at least one of: a parking merchant, a transportation merchant, and a miscellaneous merchant. In some embodiments, the one or more parking metrics may include at least one of: parking availability, parking search time, and parking cost. In one embodiment, the one or more transaction behaviors may include at least one of: transaction frequency, parking purchase frequency, transportation purchase frequency, number of transactions, and transaction merchant types.

### Exemplary Method for Generating Data Estimates of Parking Metrics Based on Transaction Behaviors

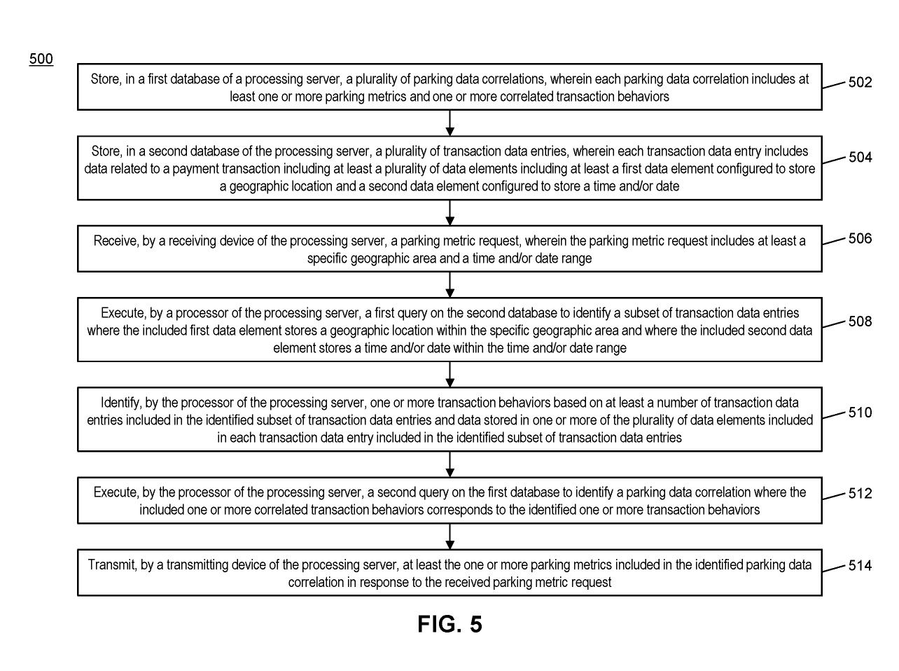

FIG. 5 illustrates a method 500 for the generation of data estimates of parking metrics for a geographic area at a time and/or date based on transaction behaviors in the geographic area for the time and/or date.

In step 502, a plurality of parking data correlations may be stored in a first database (e.g., the memory 216) of a processing server (e.g., the processing server 102), wherein each parking data correlation includes at least one or more parking metrics and one or more correlated transaction behaviors. In step 504, a plurality of transaction data entries (e.g., the transaction data entries 214) may be stored in a second database (e.g., the transaction database 212) of the processing server, wherein each transaction data entry includes data related to a payment transaction including at least a plurality of data elements including at least a first data element configured to store a geographic location and a second data element configured to store a time and/or date.

In step 506, a receiving device (e.g., the receiving unit 202) of the processing server may receive a parking metric request, wherein the parking metric request includes at least a specific geographic area and a time and/or date range. In step 508, a first query may be executed by a processor (e.g., the processing unit 204) of the processing server on the second database to identify a subset of transaction data entries where the included first data element stores a geographic location within the specific geographic area and where the included second data element stores a time and/or date within the time and/or date range.

In step 510, one or more transaction behaviors may be identified by the processor of the processing server based on at least a number of transaction data entries included in the identified subset of transaction data entries and data stored in one or more of the plurality of data elements included in each transaction data entry included in the identified subset of transaction data entries. In step 512, a second query may be executed by the processor of the processing server on the first database to identify a parking data correlation where the included one or more correlated transaction behaviors corresponds to the identified one or more transaction behaviors. In step 514, at least the one or more parking metrics included in the identified parking data correlation may be transmitted by a transmitting device (e.g., the transmitting unit 206) of the processing server in response to the received parking metric request.

In one embodiment, each transaction data entry may further include a third data element configured to store a merchant category identifier, and the one or more transaction behaviors may be further based on data stored in the third data element in each transaction data entry included in the associated subset of transaction data entries. In a further embodiment, the merchant category identifier may be indicative of at least one of: a parking merchant, a transportation merchant, and a miscellaneous merchant. In some embodiments, the one or more parking metrics may include at least one of: parking availability, parking search time, and parking cost. In one embodiment, the one or more transaction behaviors may include at least one of: transaction frequency, parking purchase frequency, transportation purchase frequency, number of transactions, and transaction merchant types.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

### Payment Transaction Processing System and Process

FIG. 7 illustrates a transaction processing system and a process 700 for the processing of payment transactions in the system, which may include the processing of thousands, millions, or even billions of transactions during a given period (e.g., hourly, daily, weekly, etc.). The process 700 and steps included therein may be performed by one or more components of the system 100 discussed above, such as the payment network 106. The processing of payment transactions using the system and process 700 illustrated in FIG. 7 and discussed below may utilize the payment rails, which may be comprised of the computing devices and infrastructure utilized to perform the steps of the process 700 as specially configured and programmed by the entities discussed below, including the transaction processing server 712, which may be associated with one or more payment networks configured to processing payment transactions. It will be apparent to persons having skill in the relevant art that the process 700 may be incorporated into the processes illustrated in FIGS. 3-5, discussed above, with respect to the step or steps involved in the processing of a payment transaction. In addition, the entities discussed herein for performing the process 700 may include one or more computing devices or systems configured to perform the functions discussed below. For instance, the merchant 706 may be comprised of one or more point of sale devices, a local communication network, a computing server, and other devices configured to perform the functions discussed below.

In step 720, an issuing financial institution 702 may issue a payment card or other suitable payment instrument to a consumer 704. The issuing financial institution may be a financial institution, such as a bank, or other suitable type of entity that administers and manages payment accounts and/or payment instruments for use with payment accounts that can be used to fund payment transactions. The consumer 704 may have a transaction account with the issuing financial institution 702 for which the issued payment card is associated, such that, when used in a payment transaction, the payment transaction is funded by the associated transaction account. In some embodiments, the payment card may be issued to the consumer 704 physically. In other embodiments, the payment card may be a virtual payment card or otherwise provisioned to the consumer 704 in an electronic format.

In step 722, the consumer 704 may present the issued payment card to a merchant 706 for use in funding a payment transaction. The merchant 706 may be a business, another consumer, or any entity that may engage in a payment transaction with the consumer 704. The payment card may be presented by the consumer 704 via providing the physical card to the merchant 706, electronically transmitting (e.g., via near field communication, wireless transmission, or other suitable electronic transmission type and protocol) payment details for the payment card, or initiating transmission of payment details to the merchant 706 via a third party. The merchant 706 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 724, the merchant 706 may enter transaction details into a point of sale computing system. The transaction details may include the payment details provided by the consumer 704 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 706 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 706 may be an online retailer in an e-commerce transaction. In such embodiments, the transaction details may be entered in a shopping cart or other repository for storing transaction data in an electronic transaction as will be apparent to persons having skill in the relevant art.

In step 726, the merchant 706 may electronically transmit a data signal superimposed with transaction data to a gateway processor 708. The gateway processor 708 may be an entity configured to receive transaction details from a merchant 706 for formatting and transmission to an acquiring financial institution 710. In some instances, a gateway processor 708 may be associated with a plurality of merchants 706 and a plurality of acquiring financial institutions 710. In such instances, the gateway processor 708 may receive transaction details for a plurality of different transactions involving various merchants, which may be forwarded on to appropriate acquiring financial institutions 710. By having relationships with multiple acquiring financial institutions 710 and having the requisite infrastructure to communicate with financial institutions using the payment rails, such as using application programming interfaces associated with the gateway processor 708 or financial institutions used for the submission, receipt, and retrieval of data, a gateway processor 708 may act as an intermediary for a merchant 706 to be able to conduct payment transactions via a single communication channel and format with the gateway processor 708, without having to maintain relationships with multiple acquiring financial institutions 710 and payment processors and the hardware associated thereto. Acquiring financial institutions 710 may be financial institutions, such as banks, or other entities that administers and manages payment accounts and/or payment instruments for use with payment accounts. In some instances, acquiring financial institutions 710 may manage transaction accounts for merchants 706. In some cases, a single financial institution may operate as both an issuing financial institution 702 and an acquiring financial institution 710.

The data signal transmitted from the merchant 706 to the gateway processor 708 may be superimposed with the transaction details for the payment transaction, which may be formatted based on one or more standards. In some embodiments, the standards may be set forth by the gateway processor 708, which may use a unique, proprietary format for the transmission of transaction data to/from the gateway processor 708. In other embodiments, a public standard may be used, such as the International Organization for Standardization's ISO 8783 standard. The standard may indicate the types of data that may be included, the formatting of the data, how the data is to be stored and transmitted, and other criteria for the transmission of the transaction data to the gateway processor 708.

In step 728, the gateway processor 708 may parse the transaction data signal to obtain the transaction data superimposed thereon and may format the transaction data as necessary. The formatting of the transaction data may be performed by the gateway processor 708 based on the proprietary standards of the gateway processor 708 or an acquiring financial institution 710 associated with the payment transaction. The proprietary standards may specify the type of data included in the transaction data and the format for storage and transmission of the data. The acquiring financial institution 710 may be identified by the gateway processor 708 using the transaction data, such as by parsing the transaction data (e.g., deconstructing into data elements) to obtain an account identifier included therein associated with the acquiring financial institution 710. In some instances, the gateway processor 708 may then format the transaction data based on the identified acquiring financial institution 710, such as to comply with standards of formatting specified by the acquiring financial institution 710. In some embodiments, the identified acquiring financial institution 710 may be associated with the merchant 706 involved in the payment transaction, and, in some cases, may manage a transaction account associated with the merchant 706.

In step 730, the gateway processor 708 may electronically transmit a data signal superimposed with the formatted transaction data to the identified acquiring financial institution 710. The acquiring financial institution 710 may receive the data signal and parse the signal to obtain the formatted transaction data superimposed thereon. In step 732, the acquiring financial institution may generate an authorization request for the payment transaction based on the formatted transaction data. The authorization request may be a specially formatted transaction message that is formatted pursuant to one or more standards, such as the ISO 8783 standard and standards set forth by a payment processor used to process the payment transaction, such as a payment network. The authorization request may be a transaction message that includes a message type indicator indicative of an authorization request, which may indicate that the merchant 706 involved in the payment transaction is requesting payment or a promise of payment from the issuing financial institution 702 for the transaction. The authorization request may include a plurality of data elements, each data element being configured to store data as set forth in the associated standards, such as for storing an account number, application cryptogram, transaction amount, issuing financial institution 702 information, etc.

In step 734, the acquiring financial institution 710 may electronically transmit the authorization request to a transaction processing server 712 for processing. The transaction processing server 712 may be comprised of one or more computing devices as part of a payment network configured to process payment transactions. In some embodiments, the authorization request may be transmitted by a transaction processor at the acquiring financial institution 710 or other entity associated with the acquiring financial institution. The transaction processor may be one or more computing devices that include a plurality of communication channels for communication with the transaction processing server 712 for the transmission of transaction messages and other data to and from the transaction processing server 712. In some embodiments, the payment network associated with the transaction processing server 712 may own or operate each transaction processor such that the payment network may maintain control over the communication of transaction messages to and from the transaction processing server 712 for network and informational security.

In step 736, the transaction processing server 712 may perform value-added services for the payment transaction. Value-added services may be services specified by the issuing financial institution 702 that may provide additional value to the issuing financial institution 702 or the consumer 704 in the processing of payment transactions. Value-added services may include, for example, fraud scoring, transaction or account controls, account number mapping, offer redemption, loyalty processing, etc. For instance, when the transaction processing server 712 receives the transaction, a fraud score for the transaction may be calculated based on the data included therein and one or more fraud scoring algorithms and/or engines. In some instances, the transaction processing server 712 may first identify the issuing financial institution 702 associated with the transaction, and then identify any services indicated by the issuing financial institution 702 to be performed. The issuing financial institution 702 may be identified, for example, by data included in a specific data element included in the authorization request, such as an issuer identification number. In another example, the issuing financial institution 702 may be identified by the primary account number stored in the authorization request, such as by using a portion of the primary account number (e.g., a bank identification number) for identification.

In step 738, the transaction processing server 712 may electronically transmit the authorization request to the issuing financial institution 702. In some instances, the authorization request may be modified, or additional data included in or transmitted accompanying the authorization request as a result of the performance of value-added services by the transaction processing server 712. In some embodiments, the authorization request may be transmitted to a transaction processor (e.g., owned or operated by the transaction processing server 712) situated at the issuing financial institution 702 or an entity associated thereof, which may forward the authorization request to the issuing financial institution 702.

In step 740, the issuing financial institution 702 may authorize the transaction account for payment of the payment transaction. The authorization may be based on an available credit amount for the transaction account and the transaction amount for the payment transaction, fraud scores provided by the transaction processing server 712, and other considerations that will be apparent to persons having skill in the relevant art. The issuing financial institution 702 may modify the authorization request to include a response code indicating approval (e.g., or denial if the transaction is to be denied) of the payment transaction. The issuing financial institution 702 may also modify a message type indicator for the transaction message to indicate that the transaction message is changed to be an authorization response. In step 742, the issuing financial institution 702 may transmit (e.g., via a transaction processor) the authorization response to the transaction processing server 712.

In step 744, the transaction processing server 712 may forward the authorization response to the acquiring financial institution 710 (e.g., via a transaction processor). In step 746, the acquiring financial institution may generate a response message indicating approval or denial of the payment transaction as indicated in the response code of the authorization response, and may transmit the response message to the gateway processor 708 using the standards and protocols set forth by the gateway processor 708. In step 748, the gateway processor 708 may forward the response message to the merchant 706 using the appropriate standards and protocols. In step 770, assuming the transaction was approved, the merchant 706 may then provide the products purchased by the consumer 704 as part of the payment transaction to the consumer 704.

In some embodiments, once the process 700 has completed, payment from the issuing financial institution 702 to the acquiring financial institution 710 may be performed. In some instances, the payment may be made immediately or within one business day. In other instances, the payment may be made after a period of time, and in response to the submission of a clearing request from the acquiring financial institution 710 to the issuing financial institution 702 via the transaction processing server 702. In such instances, clearing requests for multiple payment transactions may be aggregated into a single clearing request, which may be used by the transaction processing server 712 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 740), the transaction processing server 712 may be configured to perform authorization of transactions on behalf of the issuing financial institution 702. Such actions may be referred to as “stand-in processing,” where the transaction processing server “stands in” as the issuing financial institution 702. In such instances, the transaction processing server 712 may utilize rules set forth by the issuing financial institution 702 to determine approval or denial of the payment transaction, and may modify the transaction message accordingly prior to forwarding to the acquiring financial institution 710 in step 744. The transaction processing server 712 may retain data associated with transactions for which the transaction processing server 712 stands in, and may transmit the retained data to the issuing financial institution 702 once communication is reestablished. The issuing financial institution 702 may then process transaction accounts accordingly to accommodate for the time of lost communication.

In another example, if the transaction processing server 712 is unavailable for submission of the authorization request by the acquiring financial institution 710, then the transaction processor at the acquiring financial institution 710 may be configured to perform the processing of the transaction processing server 712 and the issuing financial institution 702. The transaction processor may include rules and data suitable for use in making a determination of approval or denial of the payment transaction based on the data included therein. For instance, the issuing financial institution 702 and/or transaction processing server 712 may set limits on transaction type, transaction amount, etc. that may be stored in the transaction processor and used to determine approval or denial of a payment transaction based thereon. In such instances, the acquiring financial institution 710 may receive an authorization response for the payment transaction even if the transaction processing server 712 is unavailable, ensuring that transactions are processed and no downtime is experienced even in instances where communication is unavailable. In such cases, the transaction processor may store transaction details for the payment transactions, which may be transmitted to the transaction processing server 712 (e.g., and from there to the associated issuing financial institutions 702) once communication is reestablished.

In some embodiments, transaction processors may be configured to include a plurality of different communication channels, which may utilize multiple communication cards and/or devices, to communicate with the transaction processing server 712 for the sending and receiving of transaction messages. For example, a transaction processor may be comprised of multiple computing devices, each having multiple communication ports that are connected to the transaction processing server 712. In such embodiments, the transaction processor may cycle through the communication channels when transmitting transaction messages to the transaction processing server 712, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 710 may identify that an authorization request involves an issuing financial institution 702 (e.g., via the bank identification number included in the transaction message) for which no value-added services are required. The transaction processor at the acquiring financial institution 710 may then transmit the authorization request directly to the transaction processor at the issuing financial institution 702 (e.g., without the authorization request passing through the transaction processing server 712), where the issuing financial institution 702 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 712 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 708, acquiring financial institution 710, etc.) for processing using this advanced network, and to quickly and efficiently receive a response regarding the ability for a consumer 704 to fund the payment transaction.

Techniques consistent with the present disclosure provide, among other features, systems and methods for generating data correlations between parking metrics and transaction behaviors and uses thereof. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for estimation of parking rates based on location and transaction data, comprising:
storing, in a transaction database of a processing server, a plurality of transaction data entries, wherein each transaction data entry is a structured data set related to a payment transaction including at least a geographic location or merchant identifier, transaction time and/or date, and transaction amount;
storing, in a location database of a processing server, a plurality of location data entries, wherein each location data entry is a structured data set related to a consumer geolocation including at least a geographic location, a location time and/or date, and a length of time;
executing, by a querying module of the processing server, a query on the transaction database to identify a subset of transaction data entries where the included geographic location or merchant identifier are associated with a parking area;
executing, by the querying module of the processing server, a query on the location database to identify a subset of location data entries where the included geographic location is included in a predefined geographic area associated with the parking area;
identifying, by a determination module of the processing server, an average parking time based on the length of time included in each of the location data entries included in the identified subset of location data entries;
identifying, by the determination module of the processing server, an average cost amount based on the transaction amount included in each of the transaction data entries included in the identified subset of transaction data entries; and
identifying, by the determination module of the processing server, an estimated parking rate for the parking area based on at least the identified average parking time and identified average cost.

2. The method of claim 1, further comprising:
receiving, by a receiving device of the processing server, a parking rate request, wherein the parking rate request includes at least the parking area; and
electronically transmitting, by a transmitting device of the processing server, the estimated parking rate in response to the received parking rate request.

3. The method of claim 1, wherein
the average parking time is identified for each of a plurality of times and/or dates based on the location time and/or date included in each of the location data entries included in the subset of location data entries,
the average cost amount is identified for each of the plurality of times and/or dates based on the transaction time and/or date included in each of the transaction data entries included in the subset of transaction data entries, and
the estimated parking rate is identified for each of the plurality of times and/or dates based on the average parking time and average cost identified for the respective time and/or date.

4. The method of claim 1, wherein the executing and identifying steps are repeated for a second parking area.

5. The method of claim 4, further comprising:
receiving, by a receiving device of the processing server, a parking rate request, wherein the parking rate request includes at least the parking area; and
electronically transmitting, by a transmitting device of the processing server, the estimated parking rate identified for the parking area and the estimated parking rate identified for the second parking area in response to the received parking rate request.

6. The method of claim 4, further comprising:
receiving, by a receiving device of the processing server, a parking rate request, wherein the parking rate request includes at least a requested geographic area;
determining, by the determination module of the processing server, a suitable parking area, wherein the suitable parking area is the parking area or the second parking area and is based on at least (i) a correspondence between the requested geographic area and the predefined geographic areas associated with the parking area and second parking area, and (ii) the estimated parking rates for the parking area and second parking area.

7. The method of claim 6, wherein
the parking rate request further includes a geographic weight and a rate weight, and
the suitable parking area is further determined based on the correspondence and geographic weight and the estimated parking rates and rate weight.

8. The method of claim 1, further comprising:
storing, in a parking database of the processing server, a parking data entry, wherein the parking data entry is a structured data set related to the parking area including at least the predefined geographic area associated with the parking area and the estimated parking rate.

9. The method of claim 1, wherein
each transaction data entry further includes an account identifier,
each location data entry further includes an account identifier,
each transaction data entry included in the identified subset of transaction data entries further includes a common account identifier, and
each location data entry included in the identified subset of location data entries further includes the common account identifier.

10. The method of claim 9, wherein
the executing and identifying steps are repeated for a plurality of different account identifiers, and
the method further comprises:
identifying, by the determination module of the processing server, an overall estimated parking rate based on the estimated parking rate for each of the plurality of different account identifiers and the common account identifier.

11. A system for estimation of parking rates based on location and transaction data, comprising:
a transaction database of a processing server configured to store a plurality of transaction data entries, wherein each transaction data entry is a structured data set related to a payment transaction including at least a geographic location or merchant identifier, transaction time and/or date, and transaction amount;
a location database of a processing server configured to store a plurality of location data entries, wherein each location data entry is a structured data set related to a consumer geolocation including at least a geographic location, a location time and/or date, and a length of time;
a querying module of the processing server configured to
execute a query on the transaction database to identify a subset of transaction data entries where the included geographic location or merchant identifier are associated with a parking area, and
execute a query on the location database to identify a subset of location data entries where the included geographic location is included in a predefined geographic area associated with the parking area; and
a determination module of the processing server configured to
identify an average parking time based on the length of time included in each of the location data entries included in the identified subset of location data entries,
identify an average cost amount based on the transaction amount included in each of the transaction data entries included in the identified subset of transaction data entries, and
identify an estimated parking rate for the parking area based on at least the identified average parking time and identified average cost.

12. The system of claim 11, further comprising:
a receiving device of the processing server configured to receive a parking rate request, wherein the parking rate request includes at least the parking area; and
a transmitting device of the processing server configured to electronically transmit the estimated parking rate in response to the received parking rate request.

13. The system of claim 11, wherein
the average parking time is identified for each of a plurality of times and/or dates based on the location time and/or date included in each of the location data entries included in the subset of location data entries,
the average cost amount is identified for each of the plurality of times and/or dates based on the transaction time and/or date included in each of the transaction data entries included in the subset of transaction data entries, and
the estimated parking rate is identified for each of the plurality of times and/or dates based on the average parking time and average cost identified for the respective time and/or date.

14. The system of claim 11, wherein the executing and identifying functions are repeated for a second parking area.

15. The system of claim 14, further comprising:
a receiving device of the processing server configured to receive a parking rate request, wherein the parking rate request includes at least the parking area; and
a transmitting device of the processing server configured to electronically transmit the estimated parking rate identified for the parking area and the estimated parking rate identified for the second parking area in response to the received parking rate request.

16. The system of claim 14, further comprising:
a receiving device of the processing server configured to receive a parking rate request, wherein the parking rate request includes at least a requested geographic area, wherein
the determination module of the processing server is further configured to determine a suitable parking area, wherein the suitable parking area is the parking area or the second parking area and is based on at least (i) a correspondence between the requested geographic area and the predefined geographic areas associated with the parking area and second parking area, and (ii) the estimated parking rates for the parking area and second parking area.

17. The system of claim 16, wherein
the parking rate request further includes a geographic weight and a rate weight, and
the suitable parking area is further determined based on the correspondence and geographic weight and the estimated parking rates and rate weight.

18. The system of claim 11, further comprising:
a parking database of the processing server configured to store a parking data entry, wherein the parking data entry is a structured data set related to the parking area including at least the predefined geographic area associated with the parking area and the estimated parking rate.

19. The system of claim 11, wherein
each transaction data entry further includes an account identifier,
each location data entry further includes an account identifier,
each transaction data entry included in the identified subset of transaction data entries further includes a common account identifier, and
each location data entry included in the identified subset of location data entries further includes the common account identifier.

20. The system of claim 19, wherein
the executing and identifying functions are repeated for a plurality of different account identifiers, and
the determination module of the processing server is further configured to identify an overall estimated parking rate based on the estimated parking rate for each of the plurality of different account identifiers and the common account identifier.
